(19) United States
(12) Patent Application Publication
(10) Pub. No.: US 2015/0225075 A1
(43) Pub. Date: Aug. 13, 2015

(54) AIRCRAFT COMPRISING A LANDING GEAR HAVING ONE WHEEL PROVIDED WITH AN ELECTRIC MOTOR AND CONTROL SYSTEM FOR SAID ELECTRIC MOTOR

(71) Applicant: Airbus Operations (SAS), Toulouse (FR)

(72) Inventors: Raphael Renier, Colomiers (FR); Xavier Guery, Toulouse (FR); Christine Charbonnier, Saint-Lys (FR); Matthieu Mayolle, Tournefeuille (FR); Sylvain Ferro, Blagnac (FR); Aurelie Treil, Toulouse (FR); Rodolphe Bonet, Toulouse (FR)

(21) Appl. No.: 14/618,356

(22) Filed: Feb. 10, 2015

(30) Foreign Application Priority Data
Feb. 10, 2014 (FR) 1451003

(51) Int. Cl. B64C 25/40; B64C 25/34; B64C 25/44; B64C 25/10

(52) U.S. Cl. CPC B64C 25/405; B64C 25/10; B64C 25/34; B64C 25/44

(57) ABSTRACT

An aircraft comprising a landing gear, having at least one wheel rotatably driven by an electric motor, and a motor control system. The control system comprises a control panel, presenting a first control configured to deliver a torque or power value to the motor along a direction of forward travel of the aircraft and second control configured to deliver a taxiing speed value along a direction of reverse travel, a control unit connected to the control panel and to the electric motor, presenting a first arrangement configured to control, in torque or power, the motor according to the value delivered by the first control, and a second arrangement configured to control, in speed, the motor according to the taxiing speed value delivered by the second control, and a speed sensor configured to measure the taxiing speed of the aircraft, and to transmit this speed information to the control unit.

### CROSS-REFERENCES TO RELATED APPLICATIONS

This application claims the benefit of the French patent application No. 1451003 filed on Feb. 10, 2014, the entire disclosures of which are incorporated herein by way of reference.

### BACKGROUND OF THE INVENTION

This invention relates to an aircraft comprising a landing gear having one wheel provided with an electric motor and a control system for said electric motor.

Equipping a landing gear of an aircraft with an electric motor is known. This electric motor is used to make the aircraft taxi when it joins the runway or when it joins its parking area.

The installation of such a motor allows the aircraft to taxi, while limiting fuel consumption, since the aircraft jet engines do not have to produce thrust.

Such an arrangement is known by the name “e-taxiing”.

However, controlling the electric motor is not at present particularly intuitive for the pilots.

### SUMMARY OF THE INVENTION

One object of this invention is to propose an aircraft that does not present the disadvantages of the prior art.

To that effect, an aircraft is proposed, comprising a landing gear, having at least one wheel provided with an electric motor, configured to drive said wheel in rotation, the aircraft furthermore including a control system for said electric motor, said control system comprising:
a control panel, presenting first control apparatus or means designed to deliver a torque or power value to be applied to said motor according to a direction of forward travel of the aircraft and second control apparatus or means means designed to deliver a taxiing speed value of the aircraft according to a direction of reverse travel of the aircraft,
a control unit connected to the control panel and to the electric motor, presenting first arrangement or means intended to control, in torque or in power, the electric motor according to the value delivered by the first control means, and second arrangement or means intended to control, in speed, the electric motor according to the taxiing speed value delivered by the second control means, and
a speed sensor intended to measure the taxiing speed of the aircraft, and to transmit this speed information to the control unit

the first control means and the second control means comprising a single rotary button presenting a zero position, where a rotation, from the zero position to a first maximum angle, in a first direction of rotation, is representative of the control torque, or power, of the electric motor, and where a rotation, from the zero position to a second maximum angle, in a second direction of rotation is representative of the control speed of the electric motor.

To that effect, an aircraft is also proposed, comprising a landing gear, having at least one wheel provided with an electric motor, configured to drive said wheel in rotation, the aircraft furthermore including a control system for said electric motor, said control system comprising:
a control panel, presenting first control apparatus or means designed to deliver a torque or power value to be applied to said motor according to a direction of forward travel of the aircraft and second control apparatus or means designed to deliver a taxiing speed value of the aircraft according to a direction of reverse travel of the aircraft,
a control unit connected to the control panel and to the electric motor, presenting a first arrangement or means intended to control, in torque or in power, the electric motor according to the value delivered by the first control means, and a second arrangement or means intended to control, in speed, the electric motor according to the taxiing speed value delivered by the second control means, and
a speed sensor intended to measure the taxiing speed of the aircraft, and to transmit this speed information to the control unit

the first control means and the second control means comprise a single mobile lever presenting a zero position, where a rotation of the lever, from the zero position towards the front of the aircraft is representative of the control torque, or power, of the electric motor, and where a rotation of the lever, from the zero position towards the rear of the aircraft is representative of the control speed of the electric motor.

Such a control system allows a feeling similar to the application of thrust by the aircraft jet engines in forward travel and allows the pilot to be relieved from the constraint of monitoring speed in reverse travel.

### BRIEF DESCRIPTION OF THE DRAWINGS

The abovementioned characteristics of the invention, as well as others, will emerge more clearly on reading the following description of an embodiment example, said description being made with reference to the attached drawings, among which:

FIG. 1 shows an aircraft according to the invention,

FIG. 2 is a diagrammatic representation of a control system for an electric motor of a landing gear of the aircraft according to the invention,

FIG. 3 is an installation mode for the electric motor of the control system on a landing gear, when the electric motor is in a disengaged position,

FIG. 4 is a representation similar to that of FIG. 3, when the electric motor is in an engaged position, and

FIG. 5 is a diagrammatic representation of a control system for an electric motor of a landing gear of the aircraft according to the invention.

### DETAILED DESCRIPTION OF THE PREFERRED EMBODIMENTS

In the description that follows, the direction of forward travel corresponds to the direction along which an aircraft moves when it advances and the direction of reverse travel corresponds to the direction along which the aircraft moves when it reverses.

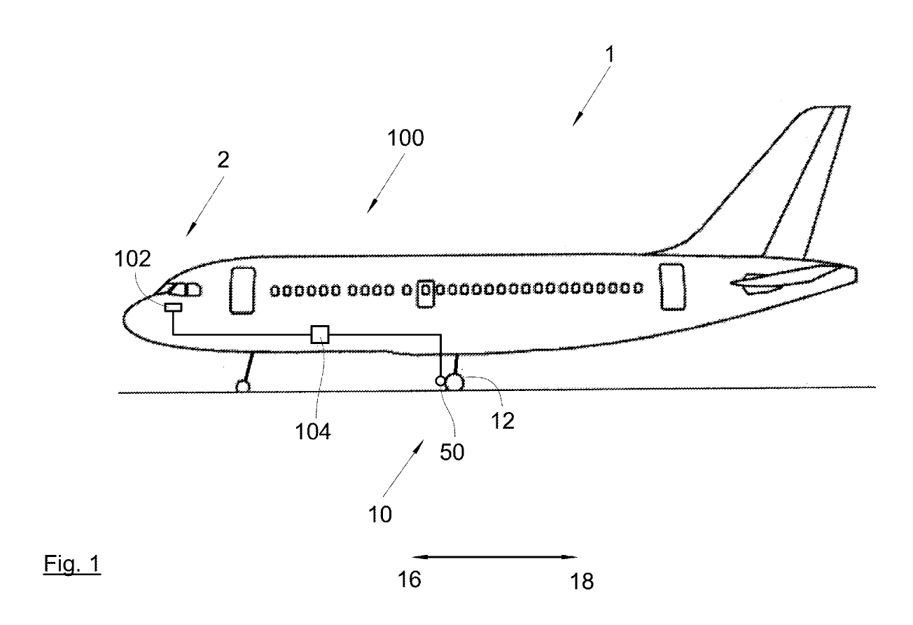

FIG. 1 shows an aircraft 1 that comprises a landing gear 10 and a flight deck 2. At least one wheel 12 of the landing gear 10 is provided with an electric motor 50 configured to drive said wheel 12 in rotation.

The aircraft 1 also comprises brakes for braking the wheel 12 and a brake pedal whose actuation activates the brakes.

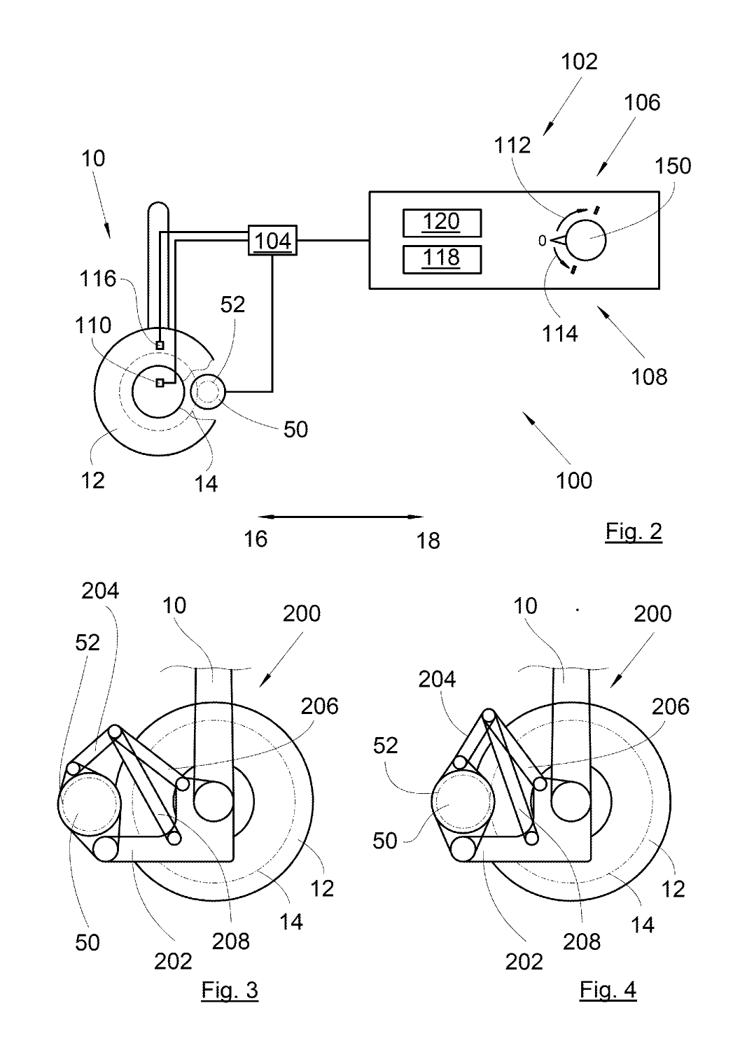

As shown in more detail in FIG. 2, the aircraft 1 comprises a control system 100 intended to control the electric motor 50.

In the embodiment of the invention presented here, the electric motor 50 is equipped with a driving gear 52 and the wheel 12 of the landing gear 10 is fitted with a driven gear 14.

When the driving gear 52 engages with the driven gear 14, the wheel 12 is driven in rotation, and the wheel 12 will drive the aircraft 1 forwards (arrow 16) or backwards (arrow 18) according to the direction of rotation of the electric motor 50.

In the embodiment of the invention presented here, a single wheel 12 of the aircraft 1 is thus equipped, but it is possible to equip one or several wheels of each landing gear.

The control system 100 comprises:
a control panel 102 arranged on the flight deck 2 of the aircraft 1 to enable it to be manipulated by a pilot, and
a control unit 104 connected to the control panel 102 and to the electric motor 50, and configured to receive instructions from the control panel 102 and to control the electric motor 50 as a function of these instructions.

The control panel 102 comprises:
first control apparatus or means 106 operable by the pilot and designed to deliver a torque or power value to be applied to said motor 50 according to the direction of forward travel 16, and
second control apparatus or means 108 operable by the pilot and designed to deliver a taxiing speed value of the aircraft 1 according to the direction of reverse travel 18.

The control unit 104 comprises:
first arrangement or means intended to control, in torque or in power, the electric motor 50 according to the value delivered by the first control means 106, that is to say when the aircraft 1 advances in the direction of forward travel 16, and
second arrangement or means intended to control, in speed, the electric motor 50 according to the taxiing speed value delivered by the second control means 108, that is to say when the aircraft 1 reverses in the direction of reverse travel 18.

Thus, when the pilot wishes the aircraft 1 to advance, he operates the first control means 106 according to the torque, or power, he wants to apply to the electric motor 50, the first control means 106 then deliver to the control unit 104 the information of the torque, or power, value that must be applied to the electric motor 50 in forward travel, and the control unit 104 then controls the electric motor 50 according to this torque, or power, instruction.

Thus, when the pilot wishes the aircraft 1 to reverse, he operates the second control means 108 according to the taxiing speed at which he wishes the aircraft 1 to reverse, the second control means 108 then deliver to the control unit 104 the information according to which the electric motor 50 must be controlled in speed and in reverse travel in such a way that the aircraft 1 reverses at said taxiing speed, and the control unit 104 then controls the electric motor 50 according to this taxiing speed instruction.

The application of a torque, or a power, to the electric motor 50 is felt by the pilot as similar to the application of a thrust by the jet engines of the aircraft 1, and slowing the aircraft 1 is performed with the help of the brakes.

The application of a reversing speed allows the pilot to be concerned only with the trajectory of the aircraft 1, while the control unit 104 controls the electric motor 50 so that the taxiing speed is respected, whatever the environment, such as, for example, the slope of the runway. The application of a zero taxiing speed with the help of the second control means 108 allows the aircraft 1 to be slowed without it being necessary to use the brakes. The acceleration and deceleration of the aircraft 1 are controlled by the control unit 104, which avoids any sudden braking that could have an impact on the longitudinal stability of the aircraft 1, and hence passenger comfort.

In order to know the taxiing speed of the aircraft 1, the control system 100 comprises a speed sensor 110 intended to measure the taxiing speed of the aircraft 1. The speed sensor 110 transmits the speed information to the control unit 104, which can then accelerate or slow the electric motor 50 according to the value of the taxiing speed captured by the speed sensor 110 and the taxiing speed to be obtained.

According to a particular embodiment of the invention, the first control apparatus or means 106 and the second control apparatus or means 108 comprise a single rotary button 150 presenting a zero position (0 in FIG. 2), where a rotation, from the zero position to a first maximum angle, in a first direction of rotation 112, is representative of the control torque, or power, of the electric motor 50, and where a rotation, from the zero position to a second maximum angle, in a second direction of rotation 114 is representative of the control speed of the electric motor 50.

According to a particular embodiment, the first maximum angle is of the order of 100° clockwise from the zero position, and the second maximum angle is of the order of 80° anticlockwise from the zero position.

In the first direction of rotation 112, the rotary button 150 takes the form of a button of the rotary potentiometer type, which, in particular, is continuous, linear and with a constant friction force between the zero position and the first maximum angle.

By rotating the rotary button 150 in the first direction of rotation 112, the pilot controls the torque, or power, value from 0% in the zero position to 100% of the torque, or power, available in the position of the first maximum angle.

The return from a position different from zero (that is to say, between the zero position and the first maximum angle) to the zero position brings about a free wheel setting of the aircraft 1, which can then only be controlled in braking by the brakes.

According to one variant, in the second direction of rotation 114, the rotary button 150 takes the form of a switch having two stable positions, namely the zero position and an engaged position corresponding to the second maximum angle, where the speed control is activated. The return to the zero position is then performed by the pilot.

By rotating the rotary button 150 in the second direction of rotation 114, the pilot controls the speed value from 0 knots (KT) in position zero to a predetermined speed in the position of the second maximum angle. The predetermined speed is preferably less than or equal to the walking speed of a person, that is to say, between 1 and 3 knots (KT) and preferably of the order of 2 knots (KT), such that a runway operator can follow the pace of the aircraft 1.

According to another variant, in the second direction of rotation 114, the rotary button 150 takes the form of a button of the switch type with one stable position corresponding to the zero position and an unstable position corresponding to the second maximum angle. Releasing the rotary button 150 from a position different from the zero position brings about its automatic return to the zero position.

According to another variant, in the second direction of rotation 114, the rotary button 150 takes the form of a button of the potentiometer type rotating between the zero position and the second maximum angle. By rotating the rotary button 150 in the second direction of rotation 114, the pilot controls the speed value from a zero value in position zero to a maximum value in the position of the second maximum angle.

The return to the zero position is then performed by the pilot, or if the potentiometer presents a single stable position corresponding to the zero position, the return to the zero position takes place automatically as soon as the pilot releases the rotary button 150.

The return from a non-zero speed position to the zero position brings about the application of a zero speed, that is to say that the control unit 104 decelerates the aircraft 1 to a standstill.

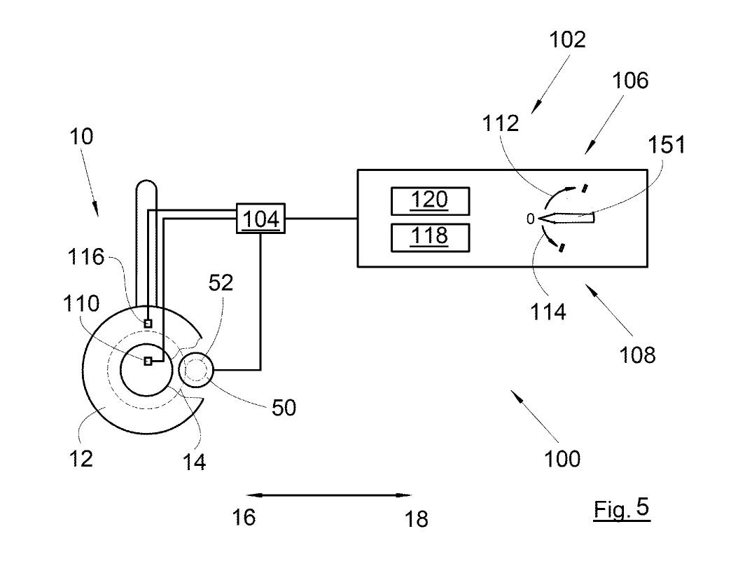

According to another particular embodiment of the invention, illustrated in FIG. 5, the first control apparatus or means and the second control apparatus or means comprises a single lever 151, rotationally mobile around a horizontal axis and preferably perpendicular to the longitudinal axis of the aircraft 1, and presenting a zero position in which the lever is perpendicular to the plane of the control panel 102, where a rotation, from the zero position to a first maximum angle, towards the front of the aircraft 1 is representative of the control torque, or power, of the electric motor 50, and where a rotation, from the zero position to a second maximum angle, towards the rear of the aircraft 1 is representative of the control speed of the electric motor 50.

In the direction of rotation towards the front, the lever 151 takes the form of a potentiometer and the pilot controls the value of the torque, or power, from 0% in zero position to 100% torque, or power, available in the position of the first maximum angle.

According to one variant, in the direction of rotation towards the rear, the lever 151 takes the form of a switch with two stable positions, namely the zero position and an engaged position corresponding to the second maximum angle where the speed control is activated. The return to the zero position is then performed by the pilot.

By rotating the lever 151 in the direction of rotation towards the rear, the pilot controls the speed value from 0 knots (KT) in position zero to a predetermined speed in the position of the second maximum angle.

According to another variant, in the direction of rotation towards the rear, the lever 151 takes the form of a switch with one stable position corresponding to the zero position and an unstable position corresponding to the second maximum angle. Releasing the lever 151 from a position different from the zero position brings about its automatic return to the zero position.

According to another variant, in the direction of rotation towards the rear, the lever 151 takes the form of a potentiometer rotating between the zero position and the second maximum angle. By rotating the lever 151 in the direction of rotation towards the rear, the pilot controls the speed value from a zero value in zero position to a maximum value in the position of the second maximum angle.

The return to the zero position is then performed by the pilot, or if the potentiometer presents a single stable position corresponding to the zero position, the return to the zero position takes place automatically as soon as the pilot releases the lever 151.

Whether in the case of the rotary button 150 or that of the lever 151, the zero position is preferably indexed, that is to say, there is a hard spot that indicates this position.

In order to prevent the pilot from inadvertently passing directly from the control in torque, or in power, to the control in speed, without passing through a stop position of the electric motor 50, the passage from the zero position to the speed control position takes place through discontinuous kinematics. The pilot must therefore perform a first operation of the rotary button 50, respectively of the lever 151, before performing the rotation specific to the control in speed. This first operation must not be a rotation that carries on from said specific rotation.

In the case of the rotary button 150, this first operation can be, for example: a pressure on the rotary button 150 or a lifting of the rotary button 150 in an axial direction. In the case of the lever 151, this first operation can be, for example: a displacement of the lever perpendicular to the central plane of the aircraft 1.

According to a preferred embodiment, the passage from taxiing in the direction of reverse travel 18 to taxiing in the direction of forward travel 16 takes place when the aircraft 1 is at a standstill, and the pilot engages the parking brake of the aircraft 1.

To that end, the control system 100 comprises a parking brake detector 116, which detects when the parking brake is or is not engaged, the parking brake detector being connected to the control unit 104. As long as, on one hand, the parking brake detector 116 does not indicate to the control unit 104 that the parking brake is engaged, and as long as, on the other hand, the speed sensor 110 does not indicate to the control unit 104 that the taxiing speed is zero, the control unit 104 stays in the zero speed control mode of the electric motor 50, and this even if another instruction is transmitted by the control panel 102.

In order to switch the control system 100 on and off, the latter presents an on-off button 118. The on-off button 118 is preferably a single shot push button, that is to say, a first pressure on the on-off button 118 switches on the control system 100 and the on-off button 118 returns to its stable position, and a second pressure on the on-off button 118 switches off the control system 100 and the on-off button 118 returns to its stable position.

In order to inform the pilot of the on-off state of the control system 100, the on-off button 118 is equipped with a light-emitting diode, which lights up when the control system 100 is on and goes out when the control system 100 is switched off.

The use of a single shot push button allows the pilot to switch off the control system 100 at will and also allows the control system 100 to switch itself off when certain particular conditions are fulfilled, for example, when a fault of the control system 100 is detected in one of the elements of the control system 100, or when the jet engines of the aircraft 1 are idling, that is to say, when the fan is turning and the thrust produced by the engine is minimum and insufficient to make the aircraft 1 move forward.

The control system 100 also comprises an incipient defect warning light 120, which lights up when a fault of the control system 100 is detected.

It can happen that, when the aircraft 1 is moving in reverse, it is necessary to make an emergency maneuver. In this case, operation of the rotary button 150, respectively the lever 151, must be immediate in order to return to the zero position. Now, locating the rotary button 150, respectively the lever 151, can take a certain time, by the time the pilot visually locates the rotary button 150, respectively the lever 151, and operates it. In order to reduce this reaction time, it is advantageous that pressure on the brake pedal, which is rapidly accessible to the pilot, triggers the transmission, to the electric motor 50, of an instruction for deceleration to a zero taxiing speed.

To that end, the control system 100 comprises an actuation detector, which is connected to the control unit 104 and which is designed to deliver information relative to the actuation or non-actuation of said brake pedal.

Therefore, when the aircraft 1 reverses and the brake pedal is actuated, the actuation detector informs the control unit 104, which then controls the electric motor 50 so as to decelerate it until a zero taxiing speed is reached, which corresponds to a deactivation of the speed control and a return to zero of the speed instruction.

According to one variant, the control system 100 is connected to at least one proximity sensor arranged on the fuselage or the wings of the aircraft 1 and connected to the control unit 104. When, during the movement of the aircraft 1 in reverse travel, a proximity sensor sends a signal to the control unit 104 whose amplitude exceeds a predetermined threshold, thereby indicating that the proximity sensor has detected a nearby obstacle, the control unit 104 then controls the electric motor 50 so as to decelerate it until a zero taxiing speed is reached.

FIG. 3 and FIG. 4 show a particular installation of the electric motor 50 on the landing gear 10.

FIG. 3 shows a disengaged position, when the driving gear 52 does not engage with the driven gear 14, and FIG. 4 shows an engaged position, when the driving gear 52 engages with the driven gear 14.

The passage from the engaged position to the disengaged position is made thanks to a swivel system 200 of the control system 100, the swivel system being designed to allow passage from the engaged position to the disengaged position, and inversely, on an instruction from the control unit 104.

The swivel system 200 here comprises a base 202 integral with and fixed to the landing gear 10, a first link rod 204, a second link rod 206, elastic means including, for example, two compression springs and a jack 208 installed in parallel with said elastic means.

For the sake of legibility, a single spring is shown, and this spring and the jack are each shown by two parallel lines bearing reference 208, but the two springs and the jack are arranged each behind the other according to a direction perpendicular to the plane of the sheet.

The electric motor 50 is installed, rotationally mobile, on the base 202, around an axis parallel to the axle of the wheel 12.

One extremity of the first link rod 204 is installed, rotationally mobile, on the electric motor 50.

One extremity of the second link rod 206 is installed, rotationally mobile, on the base 202.

The other extremity of the first link rod 204 and the other extremity of the second link rod 206 are installed, rotationally mobile with each other.

One extremity of each spring 208 is installed, rotationally mobile, at said other extremities and one extremity of the jack 208 is also installed, rotationally mobile, at said other extremities.

The other extremity of each spring 208 and the other extremity of the jack 208 are installed, rotationally mobile, on the base 202.

The springs and the jack 208 are arranged in the angle formed between the two link rods 204 and 206.

In the engaged position, the jack 208 is activated by the control unit 104 and pushes back said other extremities, which tends to bring the two link rods 204 and 206 closer together, and therefore to make the electric motor 50 pivot in order to bring it closer to the driven gear 14, and the compression springs are then tensioned.

In the disengaged position, the jack 208 is deactivated by the control unit 104 and the compression springs contract, which reduces their lengths and brings said other extremities closer, which tends to space apart the two link rods 204 and 206, and therefore to make the electric motor 50 pivot in order to move it away from the driven gear 14.

For safety reasons, only the compression springs are used in the disengaged position and any failure of the jack will therefore not have an influence on the position of the electric motor 50.

The jack 208 can be an electric jack controlled directly by the control unit 104, or a hydraulic jack controlled by the control unit 104 through the installation of a hydraulic supply diverted from a hydraulic system existing on the aircraft 1.

Aside from the inoperative mode when a fault of the control system 100 is detected, the use of the swivel system 200 allows the control system 100 to present three operating modes:

A non-activated mode, in which the control system 100 is not operating and in which the swivel system 200 holds the disengaged position.

A standby mode, in which the control system 100 is operating and in which the swivel system 200 holds the disengaged position.

An activated mode, in which the control system 100 is operating and in which the swivel system 200 holds the engaged position.

The passage from the standby mode to the activated mode takes place, for example, according to the following scheme:
the two gears are disengaged and the swivel system 200 holds the disengaged position,
the control unit 104 verifies the speed of the wheel 12 using the speed sensor 110 and the control unit 104 accelerates the electric motor 50 until it reaches the speed of the wheel 12,
when the difference in speed between the wheel 12 and the electric motor 50 is less than a threshold, the control unit 104 activates the jack 208 to pass to the engaged position, and
the driving gear 52 and the driven gear 14 engage with each other to make the aircraft 1 taxi.

The passage from the activated mode to the standby mode takes place, for example, by the jack 208 being deactivated by the control unit 104, which makes the swivel system 200 pass to the disengaged position under the action of the springs 208, then by stopping the electric motor 50.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
a landing gear, having at least one wheel provided with an electric motor, configured to drive said wheel in rotation,
a control system for said electric motor, said control system comprising:
a control panel, presenting a first control apparatus configured to deliver a torque or power value to be applied to said motor according to a direction of forward travel of the aircraft and a second control apparatus configured to deliver a taxiing speed value of the aircraft according to a direction of reverse travel of the aircraft,
a control unit connected to the control panel and to the electric motor, presenting a first arrangement configured to control, in torque or in power, the electric motor according to the value delivered by the first control apparatus, and a second arrangement configured to control, in speed, the electric motor according to the taxiing speed value delivered by the second control apparatus, and
a speed sensor configured to measure the taxiing speed of the aircraft, and to transmit this speed information to the control unit,
the first control apparatus and the second control apparatus comprising a single rotary button presenting a zero position, where a rotation, from the zero position to a first maximum angle, in a first direction of rotation, is representative of the control torque, or power, of the electric motor, and where a rotation, from the zero position to a second maximum angle, in a second direction of rotation is representative of the control speed of the electric motor.

2. The aircraft according to claim 1, further comprising a flight deck, and wherein the control panel is arranged on the flight deck.

3. The aircraft according to claim 1, wherein the aircraft comprises brakes for braking said at least one wheel and a brake pedal, whose actuation activates said brakes, the control system comprises a brake pedal actuation detector connected to the control unit, and wherein, when the aircraft moves in the direction of reverse travel and the actuation detector detects an actuation of the brake pedal, the control unit controls the electric motor so as to decelerate it until a zero taxiing speed is reached.

4. The aircraft according to claim 1, wherein the control system comprises at least one proximity sensor connected to the control unit, and wherein, when the aircraft moves in the direction of reverse travel, and wherein said, or at least one, proximity sensor detects a nearby obstacle, the control unit controls the electric motor so as to decelerate it until a zero taxiing speed is reached.

5. The aircraft according to claim 4, wherein the sensor is arranged on the wings or the fuselage of the aircraft.

6. The aircraft according to claim 1, wherein the aircraft comprises a parking brake, said control system comprises a parking brake detector connected to the control unit, and wherein the control unit is designed to stay in a zero speed control mode of the electric motor as long as the parking brake detector does not indicate that the parking brake is engaged, and as long as the speed sensor does not indicate that the taxiing speed is zero.

7. The aircraft according to claim 1, wherein said control system comprises an on-off button of the single shot push button type.

8. The aircraft according to claim 1, wherein the electric motor is equipped with a driving gear, wherein the wheel is equipped with a driven gear, and wherein the control system comprises a swivel system controlled by the control unit, the swivel system being configured to allow the passage from an engaged position, in which the driving gear engages with the driven gear, to a disengaged position, in which the driving gear does not engage with the driven gear, and inversely.

9. An aircraft comprising:
a landing gear, having at least one wheel provided with an electric motor, configured to drive said wheel in rotation,
a control system for said electric motor, said control system comprising:
a control panel, presenting a first control apparatus configured to deliver a torque or power value to be applied to said motor according to a direction of forward travel of the aircraft and a second control apparatus configured to deliver a taxiing speed value of the aircraft according to a direction of reverse travel of the aircraft,
a control unit connected to the control panel and to the electric motor, presenting a first arrangement configured to control, in torque or in power, the electric motor according to the value delivered by the first control apparatus, and a second arrangement configured to control, in speed, the electric motor according to the taxiing speed value delivered by the second control apparatus, and
a speed sensor configured to measure the taxiing speed of the aircraft, and to transmit this speed information to the control unit,
the first control apparatus and the second control apparatus comprising a single mobile lever presenting a zero position, where a rotation of the lever, from the zero position towards the front of the aircraft is representative of the control torque, or power, of the electric motor, and where a rotation of the lever, from the zero position towards the rear of the aircraft is representative of the control speed of the electric motor.

10. The aircraft according to claim 9, further comprising a flight deck, and wherein the control panel is arranged on the flight deck.

11. The aircraft according to claim 9, wherein the aircraft comprises brakes for braking said at least one wheel and a brake pedal, whose actuation activates said brakes, the control system comprises a brake pedal actuation detector connected to the control unit, and wherein, when the aircraft moves in the direction of reverse travel and the actuation detector detects an actuation of the brake pedal, the control unit controls the electric motor so as to decelerate it until a zero taxiing speed is reached.

12. The aircraft according to claim 9, wherein the control system comprises at least one proximity sensor connected to the control unit, and wherein, when the aircraft moves in the direction of reverse travel, and wherein said, or at least one, proximity sensor detects a nearby obstacle, the control unit controls the electric motor so as to decelerate it until a zero taxiing speed is reached.

13. The aircraft according to claim 12, wherein the sensor is arranged on the wings or the fuselage of the aircraft.

14. The aircraft according to claim 9, wherein the aircraft comprises a parking brake, said control system comprises a parking brake detector connected to the control unit, and wherein the control unit is designed to stay in a zero speed control mode of the electric motor as long as the parking brake detector does not indicate that the parking brake is engaged, and as long as the speed sensor does not indicate that the taxiing speed is zero.

15. The aircraft according to claim 9, wherein said control system comprises an on-off button of the single shot push button type.

16. The aircraft according to claim 9, wherein the electric motor is equipped with a driving gear, wherein the wheel is equipped with a driven gear, and wherein the control system comprises a swivel system controlled by the control unit, the swivel system being configured to allow the passage from an engaged position, in which the driving gear engages with the driven gear, to a disengaged position, in which the driving gear does not engage with the driven gear, and inversely.
